(19) United States
(12) Patent Application Publication
(10) Pub. No.: US 2007/0161461 A1
(43) Pub. Date: Jul. 12, 2007

(54) Electric laptop massager, exerciser and stimulator all in one for hands

(76) Inventor: Andy Hoi Nguyen, Aanaheim, CA (US)

Correspondence Address: Andy Hoi Nguyen, P. O. Box 4263, Garden Grove, CA, 92842, US

(21) Appl. No.: 11/328,601

(22) Filed: Jan. 11, 2006

(51) Int. Cl. A63B 23/16; A61H 1/00

(52) U.S. Cl. 482/44; 601/46

(57) ABSTRACT

This invention of innovative device is about heated massaging, stimulating and exercising particularly made for hands. With the applying of hands on a pair of heated handles that have multi heated rubber spike deep massage cones, this device can help to revitalize underneath tiny muscles to control hand's skin problems. Especially the controlling for the women with dry to crack and extreme sweat palms.

The pair of handles of this device will make a distinguish ¼ rounds countering from one to another. The agitating effective heated handles will control wrist acute pain due to getting hurt from long hour and daily working on computer key board.

### PREAMBLE

The petitioner who signature appear on the declaration attached respectfully request that Letter Patent be granted to such petitioner for the new and original utility patent set forth in the following specification. The filing fee of $500.00 2 sheet of Utility Patent Application-Preamble, Specification (3 copies ea.), 5 sheets of Patent Application (3 copies ea.), 2 sheets of formal drawing (3 copies ea.), 1 sheet of Declaration Utility Patent Claims (3 copies ea.), 1 sheet of Small Entity Declaration (3 copies ea.), and a return receipt postcard are attached.

### SPECIFICATION

The undersigned has invented a new original, and ornamental utility design entitled:

“The Electric Laptop Massager, Exerciser and Stimulator All in One for Hands” The following is a specification. Reference is made to the accompanying drawings, which form a part hereof, the figures of which are described as follow:

“The Electric Laptop Massager, Exerciser and Stimulator All in One” has two countering agitation handles that set on the two sides left and right of device. The handles will agitate opposite from each other. The agitation is driven by a slow speed electric motor. Each handle is constructed of two sections. The first section has the purpose for hands and fingers gripping to be massaging and stimulating. The second section is a half-ball ball having the same task of the first one but the use is for palms clutching. The counter agitating of handles creates the slow and strong and deep effect cycle of massage on skin. These actions of the handles also give a rhythm of exercise on wrists.

The surfaces of handles are full of stand up rubber plastic cones. There are several cones on a square inch of the surface handles. These large numbers of cones are to maximize the effect of deep massaging contact on the skin surfaces. When the cones are warmed up, together with agitating handles. This combination along with the desire of hands gripping forces will create a slow strong cycle of massage and long wavelength of vibration. The heated cones, the agitating handles, interact with the hands gripping forces will stimulate deep down tiny muscles underneath the skin.

### BACKGROUND

1. Field of Invention

Many people work with computer keyboards daily. Specially women who work long hours at the offices, their hands are under extreme stress. The hands stress from office working is a paralleled function that associates with over reacting or fatigue of the tiny muscles underneath of their palms. Thus, palms can get over perspire or sometime sweat profusely. This symptom of sweating makes the women feeling uncomfortable or embarrassing with their hands. On the other situation from the hands stress, the women's hands skins can become dried, chapped, cracked and sometimes even get infections due to the skins cracked. Lotion and medical creams are not a long-term solution. “The Electric Laptop Massager, Exerciser and Stimulator All in One for hands” will give those hands a good stimulation and relax to reduce hands glands stress. To help any underneath palms muscles from stress will eventually help control the hands skins problems of over perspiration and dryness.

2. Background Description of Art

The human hands and fingers are constructed with many thousand muscles. There are so many tiny sweat glands underneath of the skin that control the perspirations to regulate body temperature. The regulating of body temperature helps control blood circulation to support nutrients to the skins. The weather, the emotional reactions, the contacts of working conditions and some abnormalities of body will make the tiny sweat glands to exert the strong contracting.

The “Electric Laptop Massager, Exerciser and Stimulator All in One for hands” has two handles that each has two sections. The first section is for easy hand gripping. There last sections of the handles are half-ball shapes at the end that designed to fit the palms clutching.

There are several tiny D=¼″×¼″ of an inch height rubber cones set stand up and cover the entire surface of handles. These cones will create a complete, continuous contact and deep down massage and stimulate the muscles underneath the skin.

The quarter of a round swivel motions clockwise and counter clockwise of the handles turn against each other. These motions will help stabilize the exerting forces of exercise from both hands. The gripping of hand on each handle according with its counter motions will help exercise the wrists.

The providing of heat on the handles is for the comfort and helping normalizing the underneath skins muscles from hands stress. The design of “The Electric Laptop Massager, Exerciser and Stimulator All in One for Hands” gives the consumer selections of massage speeds, temperature, and exerting exercising forces. These features will create a special massage, exercise, stimulate and relax therapy for hands. This event of therapy will lead to helping a long-term control of the hands skin health problems.

### SUMMARY

“The Electric Laptop Massager, Exerciser and Stimulator All in One for Hands” has two round handles. These handles are installed and swiveling on a steel hollow shaft. The speed of the swiveling handles can be adjusted from 30 to 60 cycles of a quarter of turn in every minute. The swiveling handles have two angular directional opposite motions. One motion is clockwise and the other is counter clockwise. Each angular directional motion of one handle is as the same time countering against the other. These angular motions are driving by a slow speed electric motor.

The temperature of handles is adjustable from 100 degrees F. to 160 degrees F. The temperature of handles are providing by two heat elements inside the handles. The heat elements are installed at the end of the steel hollow shaft.

The handles are full of stand up rubber cones. There is one cone on every quarter of a square inch of the handles surfaces.

Each handle has two sections for preference of hands fitting application. The first section has its length that fits inside hand with fingers gripping around. The last section is a half-ball shape that fit for clutching of palms.

### OBJECTS, ADVANTAGES AND DESCRIPTIONS

“The Electric Laptop Massager, Exerciser and Stimulator All in One for Hands” is a device designed to sit on top of the laps for convenience of massage, exercise and stimulation of the fingers, palms and wrists.
Having the fingers, palms and wrists massaging and exercising on one's laps while being watching TV is a good way of total relaxation.
This design of “Electric Laptop Massager, Exerciser and Stimulator All in One” will encourage more frequent hands massage and exercise on the consumer's daily lives.
The counter motions of one quarter of a turn of the handles will create a stabilizing force of exercise from both hands. This motion will keep the massage and exercise going without having hands fatigued.
The stronger pressure applies on the handles is the deeper massage and stimulation deep down tiny muscles of the fingers and palms.
The stronger of hands gripping is the more force of exercise on wrists.
The consumer has the freedom of choices on level of massage, exercise and temperature at their convenience.
The providing of heat is for the preference of comfort. The right amount of heat will help a better blood circulation to palms and fingers.
The total surface cover of rubber cones together with heat on the handles will create a deep massage and stimulate of the glands, muscles of underneath of the skins of the fingers, palms and wrists.

The providing of heat, the counter angular directional motion of handles, and the complete surface cover of rubber cones, are the good and important combination that will stimulate and relax the tiny muscles of underneath the skin. Relaxing and stimulating of tiny muscles of underneath skins of fingers and palms are the main elements for helping controlling of dried hands or profusely sweat hands.

### DRAWING FIGURES

FIG. 1. It is front view of “The Electric Laptop Massager, Exerciser and Stimulator All in One for Hands”. The device has two handles designed on two sides, left and right. The dimension of first section of each handle is D=4″×2.5″ long. The last section of each handle is a half-ball shape D=3″. The surfaces of handles are full of rubber cones stand up of D=¼″×¼″ height. There is one rubber cone on every quarter of a square inch of handles surfaces.

The cover body of the device is jointed of two equal parts of front and back. These parts are made out of cast hard plastic. There are two control knobs of temperature and speed on the front part.

FIG. 2. It is Top view of the device. The very top cover of the device has a U-trough shape. The dimension of the U-trough is D=4″×7″ long.

FIG. 3. It is the bottom view of the device. The bottom of device has a rectangular shape made out of rubber-coated sheet of steel. The dimension of the sheet has a width of 8″×16″ long.

FIGS. 4 and 5. It is the side view of the device. The two sides left and right of the device are opposite identical faces with the height of 9″×16″ width.

FIG. 6. It is a perspective view of the device to help elaborate visualizing the device.

FIG. 7. It is the center cut of drawing of the device. There is a slow speed Electric Motor. The motor is installed on the steel frame that is grounding on the bottom part of the device. The handles are installed agitating on a steel hollow shaft that is rigidly set on the steel frame with the motor. The motions of handles are driving by two sets of left and right turn mechanisms. These mechanisms will create counter agitating against one another handle.

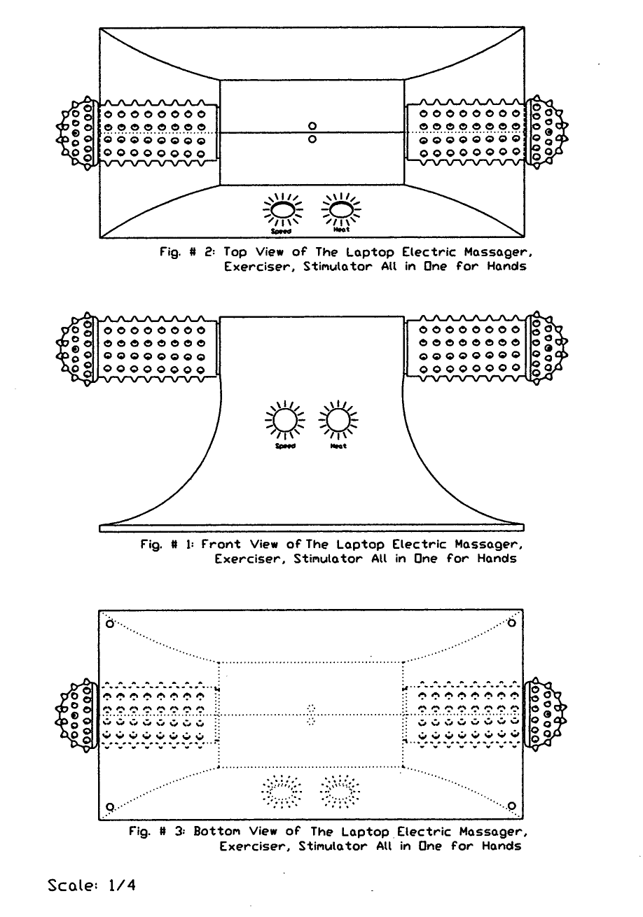

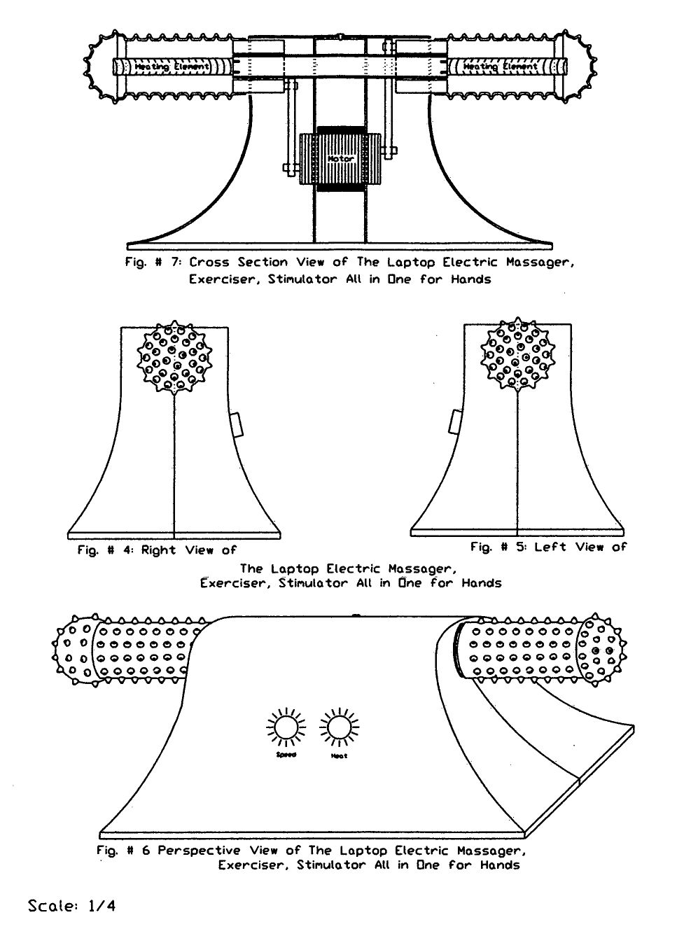

There are two heat elements installed inside the handles at the end of the hollow shaft, where the electric wiring of the heat elements must go through.

### CONCLUSION

There will be many kinds of health problems that come with the human body, time after time. Taking care of our human bodies is not a simple task. Exercising, physical therapy, mental therapy, living condition and medication are the sources of prolonging healthy living. “The Electric Laptop Massager, Exerciser and Stimulator All in One for Hands” will contribute its benefits to our healthy living, especially for normalizing healthy skin of the hands.

I claim: The “Electric Laptop Massager, Exerciser and Stimulator All in One for Hands” device has two counter agitating against each other, multi-rubber/plastic heated cones on every square inch of the handles surface. There are

5

claims for this device.

1. This device is bearing a meaningful word of “Laptop”. The watching TV and at the same time massaging hands has benefit of convenience that encourage the frequent care for hands.

2. The device has two handles that counter agitating against each other. This feature will have hands momentary gripping on handles while the device is at a stabled position. The gripping hands on handles will create movement of wrists to exercise.

3. The agitating of handles together with soft durometer rubber/plastic cones will interact with hand for rhythms of grip to create deep skin massage and long wavelength of vibration. This feature will stimulate deep down glands of skin foundation.

4. The agitating of handles together with soft durometer rubber/plastic heated cones will help palms to perspire that discharge toxin and waste. This feature also helps blood circulating somewhat better.

5. The speed of agitating of handles is adjustable for general desire. This feature will help the device to provide better consumer's preference.
